(19) United States
(12) Patent Application Publication
(10) Pub. No.: US 2015/0298627 A1
(43) Pub. Date: Oct. 22, 2015

(54) DEVICE AND METHOD FOR DISTRIBUTION OF ELECTRICAL ENERGY

(71) Applicant: BAE SYSTEMS HÄGGLUNDS AKTIEBOLAG, Örnsköldsvik (SE)

(72) Inventor: Per-Åke NORDLANDER, Bjästa (SE)

(73) Assignee: BAE Systems Hägglunds Aktiebolag, Örnsköldsvik (SE)

(21) Appl. No.: 14/649,489

(22) PCT Filed: Dec. 3, 2013
(86) PCT No.: PCT/SE2013/051435

§ 371 Date: Jun. 3, 2015

(30) Foreign Application Priority Data
Dec. 4, 2012 (SE) 1251373-5

(51) Int. Cl. B60R 16/03

(52) U.S. Cl. CPC B60R 16/03

(57) ABSTRACT

The invention relates to a method for distribution of electrical energy in a system comprising power units for production and consumption of said electrical energy, comprising a control unit for said distribution. The method comprises the steps of automatically identifying power units of the system; and automatically configuring said control unit for controlling of said distribution on the basis of the thus identified power units of the system. The invention also relates to a computer program product comprising program code for a computer for implementing a method according to the invention. The invention also relates to a device and a motor vehicle which is equipped with the device.

### TECHNICAL FIELD

The present invention relates to a method for distribution of electrical energy in a system comprising power units for production and consumption of said electrical energy. The invention also relates to a computer program product comprising program code for a computer implementing a method according to the invention. The invention also relates to a device for distribution of electrical energy in a system comprising power units for production and consumption of said electrical energy and a motor vehicle which is equipped with the device.

### BACKGROUND

Vehicles of today are provided with a number of power units for allowing operation of said vehicles. Said power units may comprise various kinds of components which can produce and consume electrical energy. Said power units may be monitored and controlled by means of one or more control units of the vehicle. Examples of said power units comprising components are a combustion engine, electrical generator, electrical inverter, electrical motor, energy storage, for example a battery or capacitor, a power net, low voltage equipment and high voltage equipment.

Said power units may be connected to a common high voltage element, for example an electrical high voltage cable.

Said at least one control unit may be arranged to control distribution of electrical energy between power units of the vehicle for achieving a suitable operation of the vehicle.

So called special vehicles, which for example may comprise any of a mining vehicle, utility vehicle or military vehicle, often provide a unique set of power units, having components which may provide unique performance. Due to the fact that said special vehicles are arranged to operate during certain circumstances and therefore are developed according to associated demand specifications, there are a large number of vehicles which present different suitable power units configurations.

A disadvantage with existing systems for distribution of electrical energy between power units for production and consumption of said electrical energy is that it is expensive to configure said at least one control unit for proper control of said special vehicle. Software for monitoring and controlling operation of said special vehicles is expensive and time demanding to develop. Further, said software is expensive to maintain and upgrade, in particular during after mounting or removal of one or more power units of the vehicle.

US 2006/0152189 A1 depicts a distributed charging system for electrical and hybrid electrical vehicles, which provides a number of battery packages having different voltages. Each battery package has a separate and independent charging system.

### SUMMARY OF THE INVENTION

An object of the present invention is to provide a novel and advantageous method for distribution of electrical energy in a system comprising power units for production and consumption of said electrical energy.

Another object of the invention is to provide a novel and advantageous device and a new and advantageous computer program for distribution of electrical energy in a system comprising power units for production and consumption of said electrical energy.

Yet another object of the present invention is to provide a method, a device and a computer program for achieving a reliable and flexible distribution of electrical energy in a system comprising power units for production and consumption of said electrical energy.

Yet another object of the invention is to provide an alternative method, an alternative device and an alternative computer program for achieving continuous distribution of electrical energy in a system comprising power units for production and consumption of said electrical energy.

Some of these objects are achieved by a method for distribution of electrical energy in a system comprising power units for production and consumption of said electrical energy according to claim 1. Other objects are achieved with a device for distribution of electrical energy in a system according to claim 14. Advantageous embodiments are depicted in the dependent claims.

According to an aspect of the invention there is provided a method for distribution of electrical energy in a system comprising power units for production and consumption of said electrical energy, comprising a control unit for said distribution. The method comprises the steps of:
automatically identifying power units of the system; and
automatically configuring said control unit for controlling said distribution on the basis of the thus identified power units of the system.

Hereby is advantageously achieved a method according to an aspect of the present invention which can be used for various vehicles with unique sets of power units. The method may advantageously be used for vehicles having a similar set of power units, where corresponding power units of different vehicles present different performance.

According to an aspect of the inventive method a proper distribution of energy between power units may be performed after a performed identification of power units in the system. Said distribution may be performed on the basis of a power request of a number of power units. Hereby an effective energy balance may be achieved, wherein an available power continuously may be distributed according to requirements of the power units connected to the system.

Said automatic identification of the power units of the system may be performed when starting the system. By initially and automatically performing said identification of power units a reliable and robust distribution of electrical energy between said power units may be achieved. The system may hereby quickly achieve correct information about power units of the system and their respective performance.

Said automatic identification of the power units of the system may be performed continuously. Hereby is achieved an accurate method for energy distribution of the system. Hereby a method may be adapted to cases where new power units are installed in the system. Hereby is provided a versatile method.

Said automatic identification of the power units of the system may relate only to active units of the system. Each power unit may provide information about whether it is active or not. This may be performed in a number of different suitable ways.

Said automatic identification of power units of the system may be performed after connection of at least one new power unit of the system. Hereby the method may be adapted to cases where new power units are installed in the system. Hereby is provided a versatile method.

Said automatic identification of power units of the system may be performed after disconnection of at least one power unit. Hereby the method may be adapted to cases where existing power units are disconnected from the system at the system. Hereby is provided a versatile method.

The method may further comprise a step of:
providing said power unit as an external unit of the system. Hereby is advantageously achieved a simple implementation of the inventive method. According to an aspect of the present invention only required software for distribution of energy needs to be installed in an existing system comprising power units for production and consumption of said electrical energy.

All power units may be connected to a common supply unit. Said supply unit may be a high voltage element. Hereby is provided a common unit for the power units, by means of which unit electrical energy may be distributed between said power units in an effective and reliable manner.

The method may further comprise the step of:
distributing said electrical energy based on availability and according to a prioritizing method. Hereby performance of the system may be optimized when a need of electrical energy of consuming power units is larger than an existing availability of electrical power of producing power units. Said prioritizing method may be implemented in a form of operation routines stored in said control unit.

Electrical energy may be produced by means of a combustion engine. Hereby the invention may be implemented in for example motor vehicles.

Said identification may comprise performance of said power units. Hereby each and one of said power units may provide information about own kind and performance to the control unit to allow an effective energy balance between power units of the system.

Said identification may be performed by means of connectors of respective power unit. Hereby an automatic and correct identification of the power units of the system may be achieved.

Said identification may be performed by means of a memory unit of respective power unit. Hereby an automatic and correct identification of the power units of the system may be performed.

The method is easy to implement in existing motor vehicles. Software for distribution of electrical energy in a system comprising power units for production and consumption of said electrical energy according to the invention may be installed in a control unit of the vehicle during manufacturing. A buyer of the vehicle may thus get the possibility to choose the function of the method as an extra feature. Alternatively, software comprising program code for performing the inventive method for distribution of electrical energy in a system comprising power units for production and consumption of said electrical energy may be installed in a control unit of the vehicle when upgrading the same at a service station. In this case the software may be downloaded into a memory in the control unit.

Software comprising program code for distributing electrical energy in a system comprising power units for production and consumption of said electrical energy may easily be updated or exchanged. Further, different parts of the software which comprises program code for distribution of electrical energy in a system comprising power units for production and consumption of said electrical energy may be exchanged independently of each other. This modular configuration is advantageous from a maintenance perspective.

According to an aspect of the invention there is provided a device for distribution of electrical energy in a system comprising power units for production and consumption of said electrical energy, comprising a control unit for said distribution. The device comprises:
means adapted to automatically identify power units of the system; and
means adapted to automatically configure said control unit for controlling said distribution on the basis of the thus identified power units of the system.

Said means for automatic identification of the power units of the system may be arranged to perform said identification when starting the system. By configuring the control unit when starting the system the one and only software be used at the different system with a respective unique set of power units. This advantageously provides that operation of a new system, having an unique power unit configuration, may be both cheaper and quicker than if a particular adapted software should be needed to be developed for each new system.

Said means for automatic identification of the power units of the system may be arranged to perform said identification continuously.

Said means for automatic identification of power units of the system may be arranged to perform said identification of active units of the system only.

Said means for automatic identification of power units of the system may be arranged to perform said identification after connection of at least one new power unit of the system.

Said means for automatic identification of power units of the system may be arranged to perform said identification after disconnection of at least one power unit.

Said control unit may be an external unit of the system.

All power units may be arranged for connection to a common supply unit.

The device may further comprise:
means adapted to distribute said electrical energy paying regard to availability and according to a prioritizing method.

The device may further comprise a combustion engine which is arranged to produce electrical energy.

Said means for identification may be arranged to determine performance of said power units.

Respective power unit may be provided with a connector, which respective connectors are arranged to provide information which is unique for each power unit. Hereby said control unit may receive a unique identification code for each power unit of the system. Hereby an effective and reliable distribution of energy between the power units of the system may be achieved. Hereby an effective and reliable prioritizing of distribution of energy between the power units of the system may be achieved.

Respective power unit may be provided with a memory unit, which respective memory unit are arranged to provide information which is unique for each power unit.

Said objects may also be achieved by a motor vehicle comprising the features of the device for distribution of electrical engine in a system comprising power units for production and consumption of said electrical energy. The motor vehicle may be a truck, bus, car, military vehicle, mining vehicle or other special vehicle.

According to an aspect of the invention there is provided a computer program for distribution of electrical energy in a system comprising power units for production and consumption of said electrical energy, wherein said computer program comprises a program code stored on a by a computer readable medium for causing an electronic control unit or another computer connected to the electronic control unit to perform the steps according to any of claims 1-13.

According to an aspect of the invention there is provided a computer program for distribution of electrical energy in a system comprising power units for production and consumption of said electrical energy, wherein said computer program comprises a program code stored on a by a computer readable medium for causing an electronic control unit or another computer connected to the electronic control unit to perform the steps according to any of claims 1-13, when said program code is run on said control unit or other computer.

According to an aspect of the invention there is provided a computer program for distribution of electrical energy in a system comprising power units, wherein said computer program comprises a program code stored on a by a computer readable medium for causing an electronic control unit or another computer connected to the electronic control unit to perform the steps according to any of claims 1-13.

According to an aspect of the invention there is provided a computer program for distribution of electrical energy in a system comprising power units for production and consumption of said electrical energy, wherein said computer program comprises a program code for causing an electronic control unit or another computer connected to the electronic control unit to perform the steps according to any of claims 1-13.

According to an aspect of the invention there is provided a computer program for distribution of electrical energy in a system comprising power units for production and consumption of said electrical energy, wherein said computer program comprises a program code for causing an electronic control unit or another computer connected to the electronic control unit to perform the steps according to any of claims 1-13, wherein said program code is run on said control unit or other computer.

According to an aspect of the invention there is provided a computer program product comprising a program code stored on a by a computer readable medium for performing the method steps according to any of claims 1-13, when said computer program is run on an electronic control unit or another computer connected to the electronic control unit.

According to an aspect of the invention there is provided a computer program product comprising a program code stored on a by a computer readable medium for performing the method steps according to any of claims 1-13, when said when said program code is run on an electronic control unit or another computer connected to the electronic control unit.

Further objects, advantages and novel features of the present invention will become apparent to those skilled in the art from the following details, as well as by practice of the invention. Even though the invention is described below it should be apparent that the invention is not limited to the specific details described. Persons skilled in the art having access to the teachings herein will recognize additional applications, modifications and incorporations in other fields, which are within the scope of the invention.

### BRIEF DESCRIPTION OF THE DRAWINGS

For a more complete understanding of the present invention and further objects and advantages thereof, reference is now made to the following detailed description to be read together with the accompanying drawings wherein the same reference numbers refer to the same parts in the various figures and in which:

FIG. 1 schematically illustrates a vehicle, according to an embodiment of the invention;

FIG. 2 schematically illustrates a device of the vehicle shown in FIG. 1, according to an embodiment of the invention;

FIG. 3 schematically illustrates a power unit of the device shown in FIG. 2, according to an embodiment of the invention;

FIG. 4a schematically illustrates a flow chart of a method, according to an embodiment of the invention;

FIG. 4b schematically illustrates in greater detail a flow chart of a method, according to an embodiment of the invention; and

FIG. 5 illustrates a computer, according to an embodiment of the invention.

### DETAILED DESCRIPTION OF THE DRAWINGS

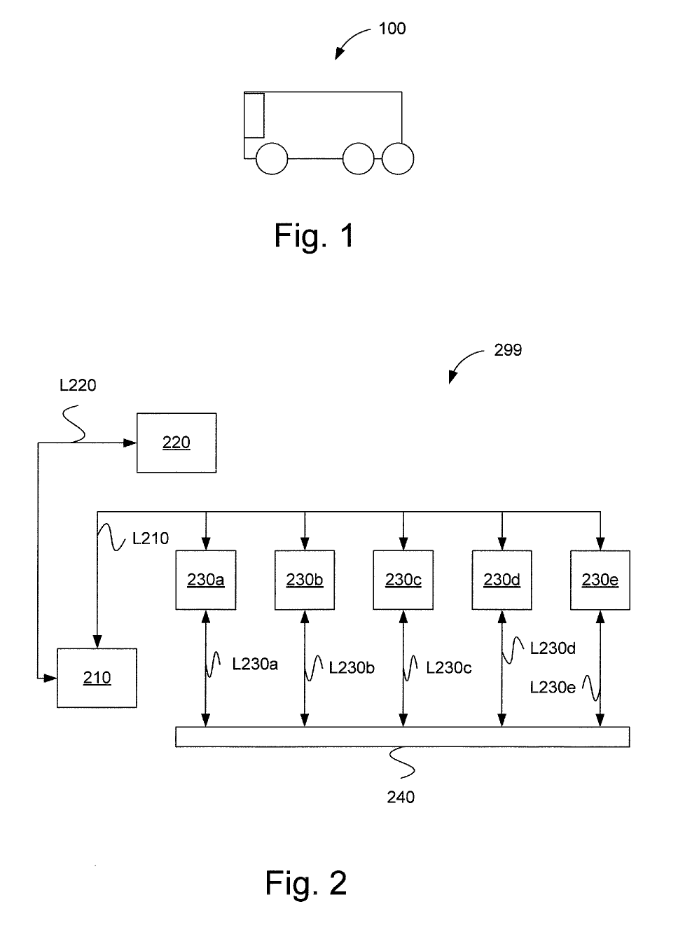

With reference to FIG. 1 there is shown a side view of a vehicle 100.

The vehicle may be a so called special vehicle. Said special vehicle may be any of a mining vehicle, wheel-loader, fire-fighting vehicle, forest machine, utility vehicle and military vehicle. Said vehicle 100 may be a ground vehicle. Said vehicle may be a terrain vehicle. Said vehicle may be a hybrid vehicle.

Said vehicle may be a heavy vehicle, such as a truck or a bus. The vehicle may alternatively be a car.

Herein the term “link” relates to a communication link, which may be a physical line such as a opto-electronic communication line or a non physical line such as a wireless connection, for example a radio- or microwave link.

With reference to FIG. 2 there is illustrated a device 299 of the vehicle 100. The device 299 is arranged in the vehicle 100 which is illustrated with reference to FIG. 1. The device 299 may also be denoted subsystem or system.

The subsystem 299 comprises a first control unit 210. Said first control unit 210 is arranged to monitor and control a number of power units of the vehicle 100. According to this embodiment the device 299 comprises five power units, namely 230a, 230b, 230c, 230d and 230e.

A first power unit 230a is arranged for communication with the first control unit 210 via a link L210. Said first power unit 230a is arranged to, where applicable, send a signal comprising information about components of the power unit 230a to the first control unit 210 via the link L210. Said first power unit 230a is arranged to, where applicable, send a signal comprising information about components of the power unit 230a and their respective performance to the first control unit 210 via the link L210. Hereby the first control unit 210 is provided with information for allowing automatic identification of the first power unit 230a. Hereby the first control unit 210 is provided with information for allowing automatic identification of the power unit 230a and its components.

The first power unit 230a is arranged to continuously send signals comprising information about current energy production/energy consumption to the first control unit 210 via the link L210. The first power unit 230a is arranged to continuously send signals comprising information about estimated energy production/energy consumption to the first control unit 210 via the link L210. The first power unit 230a according to an embodiment is arranged to continuously send signals comprising information about an expected future energy production/energy consumption to the first control unit 210 via the link L210. Hereby decision information for effectively distributing energy within the device 299 is provided.

Said first power unit 230a may comprise a combustion engine and an electric generator and an inverter unit. Said first power unit 230a is connected by at least one electrical line to a supply unit 240. Hereby a power unit is provided which both can produce and consume energy depending on vehicle parameters, such as for example desired propulsion. Said engine may be controlled by means of said first control unit according to therein stored operation routines. As an example, an operational torque requested by a driver, may constitute decision information for determining an electrical power required for operation of said first power unit 230a. According to another example the first control unit 210 may be arranged to determine a measure of electrical power said generator is generating during current operational conditions. Hereby it may be established if said first power unit 230a is producing energy, and in such a case, how much energy, or if said first power unit 230a is in a need of receiving electrical energy for proper operation, and in such a case how much energy.

Said first power unit 230a is arranged in electrical connection with said supply unit 240. Said first power unit 230a may be arranged to, by means of said first control unit 210 in a controlled way, feed electrical energy to said supply unit 240. Said first power unit 230a may be arranged to, by means of said first control unit 210 in a controlled way, be fed with electrical energy from said supply unit 240.

A second power unit 230b is arranged for communication with the first control unit 210 via the link L210. Said second power unit 230b is arranged to, where applicable, send a signal comprising information about components of the power unit 230b to the first control unit 210 via the link L210. Said second power unit 230b is arranged to, where applicable, send a signal comprising information about components of the power unit 230b and their respective performance to the first control unit 210 via the link L210. Hereby the first control unit 210 is provided with information for allowing automatic identification of the second power unit 230b. Hereby the first control unit 210 is provided with information for allowing automatic identification of the power unit 230b and its components.

The second power unit 230b is arranged to continuously send signals comprising information about current energy production/energy consumption to the first control unit 210 via the link L210. The second power unit 230b is arranged to continuously send signals comprising information about estimated energy production/energy consumption to the first control unit 210 via the link L210. The second power unit 230b is according to an embodiment arranged to continuously send signals comprising information about an expected future energy production/energy consumption. Hereby is provided decision information for allowing distribution of energy within the device 299 in an efficient way.

Said second power unit 230b may comprise a load, such as propulsion of the vehicle or a hydraulic pump, electrical engine and an inverter unit. Said second power unit 230b is connected by means of at least one electrical line to said supply unit 240. Hereby is provided a power unit which both can produce and consume energy depending on vehicle conditions, such as desired propulsion. Said electrical engine may be controlled by means of said first control unit 210 according to therein stored operational routines. As an example, an operational torque requested by a driver, may constitute decision information for determining an electrical power required for operation of said second power unit 230b. According to another example the first control unit 210 may be arranged to determine a measure of electrical power said load which is requested during current operational parameters. Hereby it may be determined if said second power unit 230b is producing energy, and in such a case, how much energy, or if said second power unit 230b is in a need of receiving electrical energy for proper operation and in such a case how much energy.

Said second power unit 230b is arranged in electrical connection with said supply unit 240. Said second power unit 230b may be arranged to by means of said first control unit 210 in a controlled way feed electrical energy to said supply unit 240. Said second power unit 230b may be arranged to, by means of said first control unit 210 in a controlled way, be fed with electrical energy from said supply unit 240.

A third power unit 230c is arranged for communication with the first control unit 210 via the link L210. Said third power unit 230c is arranged to, where applicable, send a signal comprising information about components of the power unit 230c to the first control unit 210 via the link L210. Said third power unit 230c is arranged to, where applicable, send a signal comprising information about components of the power unit 230c and their respective performance to the first control unit 210 via the link L210. Hereby the first control unit 210 is provided with information for allowing automatic identification of the third power unit 230c. Hereby the first control unit 210 is provided with information for allowing automatic identification of the power unit 230c and its components.

The third power unit 230c is arranged to continuously send signals comprising information about current energy production/energy consumption to the first control unit 210 via the link L210. The third power unit 230c is arranged to continuously send signals comprising information about estimated energy production/energy consumption to the first control unit 210 via the link L210. The third power unit 230c is according to an embodiment arranged to continuously send signals comprising information about an expected future energy production/energy consumption. Hereby decision information for allowing distribution of energy within the device 299 in an efficient way is provided.

Said third power unit 230c may comprise an energy storage, a charging unit, a DC/DC converter and an energy storage control system. Said energy storage may comprise at least one battery and/or a capacitor. Said third power unit 230c is connected by means of at least one electrical line to said supply unit 240. Said supply unit 240 may comprise high direct voltage. Hereby is provided a power unit which both can produce and consume energy depending on vehicle conditions, such as for example desired propulsion. Said energy storage may be controlled by means of said first control unit 210 and/or said energy storage control unit according to therein stored operation routines. Hereby for example a current charging degree of a battery may constitute decision information for determining a measure of electrical power being required for operation (for example charging of a battery) of said third power unit 230c. According to another example the first control unit 210 may be arranged to determine a measure of electrical power said energy storage may provide during current operational conditions. According to another example the first control unit 210 may be arranged to determine a measure of electrical power said charging unit may provide during current operational conditions. Hereby it may be determined if said third power unit 230c may provide energy, and in such a case how much energy, or if said third power unit 230c is in a need of receiving electrical energy supplied for proper operation (for example charging of a battery) and in such a case how much energy.

Said third power unit 230c is arranged in electrical connection with said supply unit 240. Said third power unit 230c may be arranged to, by means of said first control unit 210 in a controlled way, feed electrical energy to said supply unit 240. Said third power unit 230c may be arranged to, by means of said first control unit 210 in a controlled way, be fed with electrical energy from said supply unit 240.

A fourth power unit 230d is arranged for communication with the first control unit 210 via the link L210. Said fourth power unit 230d is arranged to, where applicable, send a signal comprising information about components of the power unit 230d to the first control unit 210 via the link L210. Said fourth power unit 230d is arranged to, where applicable, send a signal comprising information about components of the power unit 230d and their respective performance to the first control unit 210 via the link L210. Hereby the first control unit 210 is provided with information for allowing automatic identification of the fourth power unit 230d. Hereby the first control unit 210 is provided with information for allowing automatic identification of the power unit 230d and its components.

The fourth power unit 230d is arranged to continuously send signals comprising information about current energy production/energy consumption to the first control unit 210 via the link L210. The fourth power unit 230d is arranged to continuously send signals comprising information about estimated energy production/energy consumption to the first control unit 210 via the link L210. The fourth power unit 230d is according to an embodiment arranged to continuously send signals comprising information about an expected future energy production/energy consumption. Hereby decision information for allowing distribution of energy within the device 299 in an efficient way is provided.

Said fourth power unit 230d may comprise a high voltage equipment. Said high voltage may be in the magnitude of 120, 300, 500, 700 or 1000 Volt. Said high voltage equipment may comprise arbitrary suitable devices. Said fourth power unit 230d is connected by means of at least one electrical line to said supply unit 240. Hereby is provided a power unit which both can produce and consume energy depending on vehicle conditions, such as for example desired propulsion. Said high voltage equipment may be controlled by means of said first control unit 210 according to therein stored operation routines. Hereby for example current operational parameters of the high voltage equipment may constitute decision information for determining a measure of electrical power which is required for operation of said fourth power unit 230d. According to another example the first control unit 210 may be arranged to determine a measure of electrical power said high voltage equipment may provide during current operational conditions. Hereby it may be determined if said fourth power unit 230d may provide energy, and in such a case how much energy, or if said third power unit 230c is in a need of receiving electrical energy supplied for proper operation and in such a case how much energy.

Said fourth power unit 230d is arranged in electrical connection with said supply unit 240. Said fourth power unit 230d may be arranged to, by means of said first control unit 210 in a controlled way, feed electrical energy to said supply unit 240. Said fourth power unit 230d may be arranged to, by means of said first control unit 210 in a controlled way, be fed with electrical energy from said supply unit 240.

A fifth power unit 230e is arranged for communication with the first control unit 210 via the link L210. Said fifth power unit 230e is arranged to, where applicable, send a signal comprising information about components of the power unit 230e to the first control unit 210 via the link L210. Said fifth power unit 230e is arranged to, where applicable, send a signal comprising information about components of the power unit 230e and their respective performance to the first control unit 210 via the link L210. Hereby the first control unit 210 is provided with information for allowing automatic identification of the fifth power unit 230e. Hereby the first control unit 210 is provided with information for allowing automatic identification of the power unit 230e and its components.

The fifth power unit 230e is arranged to continuously send signals comprising information about current energy production/energy consumption to the first control unit 210 via the link L210. The fifth power unit 230e is arranged to continuously send signals comprising information about estimated energy production/energy consumption to the first control unit 210 via the link L210. The fifth power unit 230e is according to an embodiment arranged to continuously send signals comprising information about an expected future energy production/energy consumption. Hereby decision information for allowing distribution of energy within the device 299 in an efficient way is provided.

Said fifth power unit 230e may comprise a low voltage equipment and a transforming unit for transforming high voltage to low voltage, and vice versa. Said low voltage may be of the magnitude 12 or 24 Volt. Said low voltage equipment may comprise arbitrary suitable devices.

Said fifth power unit 230e is connected by means of at least one electrical line to said supply unit 240. Hereby is provided a power unit which both can produce and consume energy depending on vehicle conditions, such as for example desired propulsion. Said low voltage equipment may be controlled by means of said first control unit 210 according to therein stored operation routines. Hereby for example current operational conditions of the low voltage equipment may constitute decision information for determining a measure of electrical power which is required for operation of said fifth power unit 230e. According to another example the first control unit 210 may be arranged to determine a measure of electrical power said low voltage equipment may provide during current operational conditions. Hereby it may be determined if said fifth power unit 230e may provide energy, and in such a case how much energy, or if said third power unit 230c is in a need of receiving electrical energy supplied for proper operation and in such a case how much energy.

Said fifth power unit 230e is arranged in electrical connection with said supply unit 240. Said fifth power unit 230e may be arranged to, by means of said first control unit 210 in a controlled way, feed electrical energy to said supply unit 240. Said fifth power unit 230e may be arranged to, by means of said first control unit 210 in a controlled way, be fed with electrical energy from said supply unit 240.

Said first control unit 210 is arranged for communication with the five power units 230a, 230b, 230c, 230d and 230e via a link L210. According to one example said first control unit 210 is arranged for communication with each and one of said five power units 230a, 230b, 230c, 230d and 230e via a respective link (not shown). According to an alternative embodiment even the second control unit 220 may be arranged for communication with said power units 230a, 230b, 230c, 230d and 230e in a suitable way, directly or via the link L220 and the first control unit 210.

The device 299 may comprise an arbitrary suitable set of power units. The device 299 may comprise at least two power units. The device 299 may comprise a suitable number of power units. Said power units may be detachably connected to the device 299. Connected power units may be activated and deactivated in a controlled way. The power units of the device 299 may present an arbitrary suitable performance.

A supply unit 240 is arranged in the vehicle 100. Said supply unit 240 may for example be a line or a network. Said supply unit 240 may be powered at a high voltage, for example 500, 700 or 900 Volt.

According to an embodiment all power units 230a, 230b, 230c, 230d and 230e are electrically connected to the supply unit 240 via lines L230a, L230b, L230c, L230d and L230e, respectively, which is shown in FIG. 2.

A second control unit 220 is arranged for communication with the first control unit 210 via a link L220. The second control unit 220 may be detachably connected to the first control unit 210. The second control unit 220 may be a to the vehicle 100 external control system. According to an embodiment said second control unit 220 is a vehicle control unit adapted for controlling operation of the vehicle 100.

According to an aspect of the invention the device 299 may be after mounted to the vehicle 100. Hereby some power units may already be arranged at the vehicle 100, while the device 299 may comprise some other power units. Hereby the second control unit 220 may be a vehicle control unit arranged in the vehicle 100. Hereby the first control unit 210 may be connected to the second control unit 220 for operation.

The second control unit 220 may be arranged to perform the inventive method steps according to the invention. The second control unit 220 may be used to load software to the first control unit 210, in particular software for performing the inventive method. The second control unit 220 may alternatively be arranged for communication with the first control unit 220 via an internal network in the vehicle. The second control unit 220 may be arranged to perform essentially the same function as the first control unit 210.

The first control unit 210 is arranged to control operation of the vehicle 100 and hereby the device 299. Hereby the first control unit 210 is arranged to determine information about for example by units of the vehicle requested torques, rotational speed, operational power etc. The first control unit 210 is arranged to calculate an energy state of the device 299. The first control unit 210 is arranged to calculate how much energy said power units may generate and how much energy said power units are about to consume and control a energy distribution between said power units in a suitable way.

In a case where less energy is produced by the power units than what is intended to be consumed of the power units the first control unit 210 is arranged to control energy distribution between said power units according to stored routines for a prioritizing method. This means that some power units which are intended to consume energy at certain operational conditions may be without power support, or only will get a part of requested energy supply.

In a memory the first control unit 210 a list with existing power units may be stored. The first control unit 210 is arranged to when starting the device 299 intermittently or continuously identify which power units of the device are connected and/or activated and update said list. Hereby is provided a way of automatically configuring said control unit 210 for controlling distribution of energy within the device 299 on the basis of the thus identified power units of the system.

It should be noted that within the device 299 the response time of the power units are important to achieve a stable device according to the invention. For example a combustion engine can not change rotational speed too fast but is constrained by for example its own performance.

An example of another configuration relates to how energy limitations in the device should be during over temperature. For example rotational speed and torque limitations in the four quadrants may be relevant for configuration of the first control unit 210. The first quadrant relates to clockwise or counter clockwise on the engine as well as pushing or breaking torque.

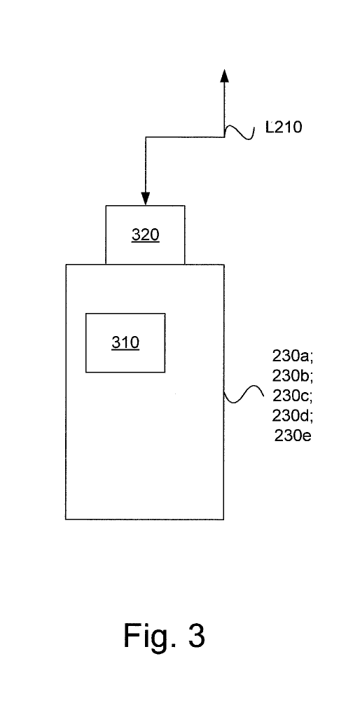

FIG. 3 schematically illustrates a power unit of the system 299. The power unit may be any of the power units 230a, 230b, 230c, 230d or 230e.

The power unit is equipped with a memory unit 310. In said memory unit 310 there is information comprising information about said power unit. Said information may comprise information about identification number of said power unit and/or identification number of the components of the power unit. Said information may comprise information about performance of said power unit and/or performance of the components of the power unit. Said information may comprise information about kind relating to said power unit and/or kind of component of the power unit.

Said power unit is arranged to send said information to the first control unit 210 via the link L210. Said power unit may be arranged to send said information to the first control unit 210 via the link L210 when starting the system 299. Said power unit may be arranged to continuously send said information to the first control unit 210 via the link L210. Said power unit may be arranged to intermittently send said information to the first control unit 210 via the link L210. Said power unit may be arranged to where applicable send said information to the first control unit 210 via the link L210. Said power unit may be arranged to when activating or deactivating the power unit send said information to the first control unit 210 via the link L210. Said power unit may be arranged to when being connected or disconnected by the power unit send said information to the first control unit 210 via the link L210.

The power unit is hereby equipped with a connector 320. Said connector 320 is arranged to provide information comprising information about said power unit. Pins of said connector 320 may be configured to provide said information in a suitable way. According to one embodiment the first control unit 210 is arranged to receive an identification signal from said power unit by means of said connector and perform an identification procedure for determining information about said power unit. Said information may comprise information about identification number of said power unit and/or identification number of the components of the power unit. Said information may comprise information about performance of said power unit and/or performance of the components of said power unit. Said information may comprise information about kind relating to said power unit and/or kind relating to the components of the power unit.

Said power unit is arranged to send said information to the first control unit 210 via the link L210. Said power unit may be arranged to send said information to the first control unit 210 via the link L210 when starting the system 299. Said power unit may be arranged to continuously send said information to the first control unit 210 via the link L210. Said power unit may be arranged to intermittently send said information to the first control unit 210 via the link L210.

Said power unit may be arranged to where applicable send said information to the first control unit 210 via the link L210. Said power unit may be arranged to when activating or deactivating the power unit send said information to the first control unit 210 via the link L210. Said power unit may be arranged to when being connected or disconnected by the power unit send said information to the first control unit 210 via the link L210.

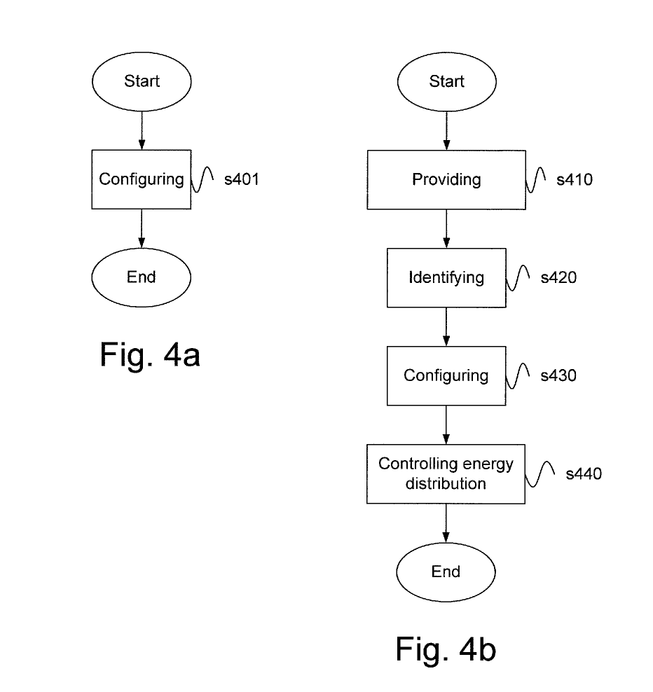

FIG. 4a schematically illustrates a flow chart of a method for distribution of electrical energy in a system comprising power units for production and consumption of said electrical energy, comprising a control unit for said distribution according to an embodiment of the invention. The method comprises a first method step s401. The step s401 comprises the steps of:
automatically identifying power units of the system; and
automatically configuring said control unit for controlling said distribution on the basis of the thus identified power units of the system. After the step s401 the method ends.

FIG. 4b schematically illustrates a flow chart of a method for distribution of electrical energy in a system comprising power units for production and consumption of said electrical energy, comprising a control unit for said distribution, according to an embodiment of the invention.

The method comprises a first method step s410. The method step s410 comprises the step of providing a set of power units of the system 299. Said set of power units may comprise any of said depicted power units 230a-230e. According to an alternative one or more other power units may be connected to the system 299. After the method step s410 there is performed a subsequent method step s420.

The method step s420 comprises the step of automatically identifying said provided power units of the system 299. Said automatic identification of power units of the system may be performed when starting the system. Said start of the system may be essentially simultaneously as a start of the vehicle 100. Said automatic identification of power units of the system may be performed continuously during operation of the system. Said automatic identification of the power units of the system may only relate to active units of the system. Said identification may comprise performance of said power units. Said identification may be performed by means of connectors of respective power unit. Said identification may be performed by means of a memory unit of the respective provided power units of the system 299. After the method step s420 there is performed a subsequent method step s430.

The method step s430 comprises a step of automatically configuring the first control unit 210 for controlling said distribution on the basis of the thus identified power units of the system 299. Hereby the first control unit 210 is adapted for adequate operation of the provided power units. After the method step s430 there is performed a subsequent method step s440.

The method step s440 comprises the step of controlling distribution of electrical energy of the power units of the system. Controlling distribution of electrical energy within the system 299 may be performed on the basis of current operational conditions of the vehicle. Controlling of distribution of electrical energy within the system 299 may be performed on the basis of a measure of energy requested by the power units.

Controlling of distribution of electrical energy within the system 299 may be performed on the basis of by the power units produced energy. After the method step s440 the method ends.

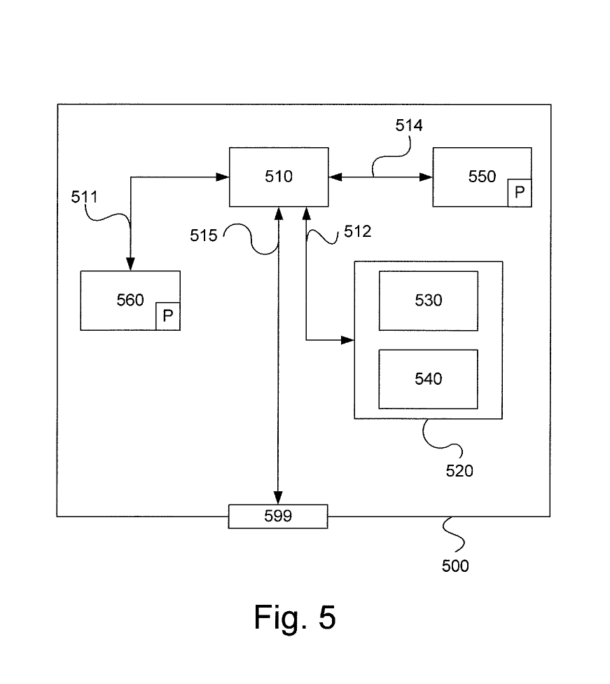

Referring to FIG. 5 a diagram of an embodiment of a device 500 is shown. The control units 200 and 210 which are depicted according to FIG. 2 may according to an embodiment comprise the device 500. The device 500 comprises a non volatile memory 520, a data processing unit 510 and a read/write memory 550. The non volatile memory 520 has a first memory portion 530 wherein a computer program such as an operation system, is stored for controlling the function of the device 500. Further the device 500 comprises a bus controller, a serial communication port, I/O means, an A/D converter, a time- and date input- and transmission unit, an event counter and an interrupt controller (not shown). The non volatile memory 520 also has a second memory portion 540.

There is provided a computer program P comprising routines for distribution of electrical energy in a system comprising power units for production and consumption of said electrical energy. The computer program P comprises routines for automatically identifying power units of the system. The computer program P comprises routines for automatically configuring said control unit for controlling of said distribution on the basis of the thus identified power units of the system. The computer program P comprises routines for performing an automatic identification of the power units of the system when starting the system. The computer program P comprises routines for continuously performing an automatic identification of the power units of the system. The computer program P comprises routines for automatic identification of the power units of the system only regarding active units of the system. The computer program P comprises routines for performing said automatic identification of the power units of the system after connecting at least one new power unit of the system. The computer program P comprises routines for performing said automatic identification of the power units of the system after disconnection of at least one power unit. The computer program P comprises routines for monitoring and controlling all power units which are connected to a common supply unit. The computer program P comprises routines for distributing said electrical energy on the basis of availability and according to a prioritizing method. The computer program P comprises routines for performing said identification, wherein said identification comprises performance of said power units. The computer program P comprises routines for performing said identification, wherein said identification is performed by means of connectors of respectively power unit. The computer program P comprises routines for performing said identification, wherein said identification is performed by means of a memory unit of respectively power unit.

The computer program P may be stored in an executable manner or in a compressed manner in a memory 560 and/or in a read/write memory 550.

When it is described that the data processing unit 510 performs a specific function it should be understood that the data processing unit 510 performs a specific part of the program which is stored in the memory 560 or a certain part of the program which is stored in the read/write memory 550.

The data processing unit 510 can communicate with a data port 599 via a data bus 515. The non volatile memory 520 is adapted for communication with the data processing unit 510 via a data bus 512. The separate memory 560 is arranged for communication with the data processing unit 510 via a data bus 511. The read/write memory 550 is arranged for communication with the data processing unit 510 via a data bus 514. To the data port 599 for examples the links L210 and L220 may be connected (see FIG. 2).

When data is received at the port 599 it is stored temporarily in the second memory portion 540. When the received input data has been temporarily stored the data processing unit 510 is prepared to perform execution of code in a way that has been depicted above. According to one embodiment the signals received at the data port 599 comprises information about performance of a power unit. According to an embodiment the signals received on the data port 599 comprises information about a unique identification number of a power unit 230a-230e. According to one embodiment signals received at the data port 599 comprises information about whether a power unit 230a-230e is active or not. According to one embodiment the signals received at the data port 599 comprises information about a current need of supplied energy of a power unit 230a-230e. According to one embodiment the signals received at the data port 599 comprises information about a measure of current produced energy of a power unit 230a-230e, which energy fully or partly may be distributed to other power units within the system.

The signals received on the data port 599 may be used the device 500 to:
automatically identifying power units of the system; and
automatically configuring said control unit for controlling said distribution on the basis of the thus identified power units of the system.

The parts of the method described herein may be performed by the device 500 by means of the data processing unit 510 which runs the program stored in a memory 560 or read/write memory 550. When the device 500 is running the program the herein described methods are executed.

The previous description of the preferred embodiments of the present invention has been provided for the purpose of illustration and description of the invention. It is not meant to be comprehensive or to limit invention to the described embodiment. Obviously many modifications and variations will become apparent to the skilled person. The embodiments were chosen and described to best explain the principals of the invention and its practical applications, thereby allowing persons skilled in the art to understand the invention for various embodiments and with the various modifications suitable for the intended use.

1. A method for distribution of electrical energy in a system comprising power units for production and consumption of said electrical energy, comprising a control unit for said distribution, the method comprising:
automatically identifying power units of the system; and
automatically configuring said control unit for controlling said distribution on the basis of the thus identified power units of the system.

2. The method of claim 1, wherein said automatic identification of the power units of the system is performed when starting the system.

3. The method of claim 1, wherein said automatic identification of the power units of the system is performed continuously.

4. The method of claim 1, wherein said automatic identification of the power units of the system only relates to active units of the system.

5. The method of claim 1, wherein said automatic identification of the power units of the system is performed after connection of at least one new power unit of the system.

6. The method of claim 1, wherein said automatic identification of the power units of the system is performed after disconnection of at least one power unit.

7. The method of claim 1, further comprising the step of:
providing said control unit as an external unit of the system.

8. The method of claim 1, wherein all power units are connected to a common supply unit.

9. The method of claim 1, further comprising the step of:
distributing said electrical energy based on availability and according to a prioritizing method.

10. The method of claim 1, where an electrical energy is produced by means of a combustion engine.

11. The method of claim 1, wherein said identification comprises performance of said power units.

12. The method of claim 1, wherein said identification is performed by means of connectors of respective power unit.

13. The method of claim 1, wherein said identification is performed by means of a memory unit of respective power unit.

14. A device for distribution of electrical energy in a system comprising power units for production and consumption of said electrical energy, comprising a control unit for said distribution, the device comprising:
a portion adapted to automatically identify power units of the system; and
a portion adapted to automatically configure said control unit for controlling said distribution on the basis of the thus identified power units of the system.

15. The device of claim 14, wherein said portion for automatic identification of power units of the system is arranged to perform said identification when starting the system.

16. The device of claim 14, wherein said portion for automatic identification of power units of the system is arranged to perform said identification continuously.

17. The device of claim 14, wherein said portion for automatic identification of power units of the system is arranged to perform said identification of only active units of the system.

18. The device of claim 14, wherein said portion for automatic identification of power units of the system is arranged to perform said identification after connection of at least one new power unit of the system.

19. The device of claim 14, wherein said portion for automatic identification of power units of the system is arranged to perform said identification after disconnection of at least one power unit.

20. The device of claim 14, wherein said control unit is an external unit of the system.

21. The device of claim 14, wherein all power units are arranged for connection to a common supply unit.

22. The device of claim 14, further comprising:
portion adapted to distribute said electrical energy paying regard to availability and according to prioritizing procedure.

23. The device of claim 14, further comprising a combustion engine which is arranged to produce electrical energy.

24. The device of claim 14, wherein said portion for identifying is arranged to determine performance of said power units.

25. The device of claim 14, wherein respective power unit is equipped with connectors, which respective connectors are arranged to provide information which is unique for respective power unit.

26. The device of claim 14, wherein respective power unit is equipped with a memory unit, which respective memory unit is arranged to provide information which is unique for respective power unit.

27. A motor vehicle comprising a device according to claim 14.

28. The motor vehicle of claim 27, wherein the motor vehicle is any of a truck, bus, car, military vehicle, mining vehicle or other special vehicle.

29. A computer program, stored in a non-transitory recording medium, for distribution of electrical energy in a system comprising power units for production and consumption of said electrical energy, wherein said computer program comprises program code for causing an electronic control unit or another computer connected to the electronic control unit to perform the steps according to claim 1.

30. A computer program product comprising a program code stored on a non-transitory computer readable medium for performing the method steps according to claim 1, when said program code is run on an electronic control unit or another computer connected to the electronic control unit.
